(19) United States
(12) Patent Application Publication
(10) Pub. No.: US 2026/0113595 A1
(43) Pub. Date: Apr. 23, 2026

(54) SYSTEM AND METHOD FOR MONITORING FIXTURE POSITION

(71) Applicant: UNEFI INC., Toronto (CA)

(72) Inventors: Ranko DIMIC, Toronto (CA); Samuel Arthur VISE, Toronto (CA); Tibor SZANTO, Toronto (CA)

(73) Assignee: UNEFI INC., Toronto (CA)

(21) Appl. No.: 19/152,716

(22) PCT Filed: Jan. 31, 2024
(86) PCT No.: PCT/CA2024/050114

§ 371 Date: Jul. 31, 2025

Related U.S. Application Data
(60) Provisional application No. 63/482,471, filed on Jan. 31, 2023.

(51) Int. Cl. H04W 4/029; H04W 4/02; H04W 4/021

(52) U.S. Cl. CPC H04W 4/029; H04W 4/022; H04W 4/023

(57) ABSTRACT

A system and method for monitoring the positions of fixtures are disclosed. A tracking unit is attached to a fixture and sends position information to a server by way of a third-party intermediary device. The server determines whether the fixture is within a predetermined first radius around a designated position for the fixture. When the fixture is within the first radius, the fixture is determined to be ‘in position’. When the fixture is outside of the first radius, the fixture is determined to be ‘out of position’ and the server sends an alert to at least one designated computing device.

### TECHNICAL FIELD

The present invention relates to monitoring systems. More specifically, the present invention relates to registering the position of a fixture at a specific location, monitoring the fixture's position, and providing an alert if the fixture moves from its registered position.

### BACKGROUND

Retail stores contain many fixtures, including more permanent fixtures such as shelving units and tables, and less-permanent fixtures such as movable advertising displays, endcaps, standees, etc. The layout of a retail store is often highly complex, with specific displays and other fixtures having specific designated locations based on traffic flow, purchasing patterns, and so on. Additionally, third-party brands often pay retail stores to display temporary fixtures advertising specific products or brands. It is important for such fixtures to remain in their designated and/or paid-for locations within the store, rather than being moved around or potentially out of the store.

Further, there is currently no way to inspect the positioning of such fixtures except to do so visually, i.e., in person. This is a particular issue for marketing managers and other personnel for large retail chains, who may have oversight of dozens of store locations. Similarly, marketing personnel for third-party brands may have oversight of contracts for hundreds or thousands of display fixtures at far-flung locations. Personal visits to each store to inspect the fixtures are thus time-consuming and commonly impractical. Additionally, the fixtures could be moved or displaced in between such visits. As such, there is a need for systems that can consistently monitor the positioning of fixtures and that can send alerts to designated users/devices when undesirable movement of the fixtures occurs.

### SUMMARY

This document discloses a system and method for monitoring the positions of fixtures at locations, including furniture elements and display elements. A tracking unit is attached to a fixture and sends position information to a server. The position information is communicated via a third-party monitoring device, such as a third-party smart phone configured to receive and transmit third-party tracking information. The server determines whether the fixture is within a predetermined first radius around a designated position for the fixture. When the fixture is within the first radius, the fixture is determined to be ‘in position’. When the fixture is outside of the first radius, the fixture is determined to be ‘out of position’ and the server sends an alert to at least one designated computing device. In some embodiments, the fixture is also associated with a predetermined second radius that is larger than the first radius. If the fixture is determined to be outside of this second radius, the alert sent to the at least one designated person indicates that the fixture is no longer at the location. In some embodiments, the location is a retail location.

In a first aspect, this document discloses a system for monitoring a position of a fixture at a location, the system comprising: a tracking unit, said tracking unit being attached to said fixture; and a server for receiving signals from said tracking unit, wherein said fixture has a designated position at said location and said fixture is associated with a first radius, said first radius being centered at said designated position, wherein said server receives position information for said fixture by way of said tracking unit and by way of at least one intermediary device, said at least one intermediary device receiving signals from said tracking unit and reporting to said server, and wherein, when said position information indicates that said position of said fixture is outside of said first radius, said server sends an alert to at least one designated computing device.

In another embodiment, this document discloses a system wherein said alert indicates that said fixture is out of said designated position.

In another embodiment, this document discloses a system wherein said server receives reports related to a plurality of tracking units, said plurality of tracking units being attached to different fixtures at said location.

In another embodiment, this document discloses a system wherein said fixture is also associated with a second radius, said second radius being larger than said first radius and said second radius being centered at said designated position, and wherein, when said position information indicates that said fixture is outside said second radius, said alert indicates that said fixture has been removed from the location.

In another embodiment, this document discloses a system wherein said alert comprises a link to a map interface, and, when accessed by the user, said map interface displays an estimated current location of said fixture.

In another embodiment, this document discloses a system further comprising a map interface for viewing an estimated current location of said fixture.

In another embodiment, this document discloses a system wherein said fixture comprises at least one of: a shelf; a shelf unit; a display; a display unit; an endcap; a standee; a poster; a rack; a table; a cabinet; a furniture element; and a marketing element.

In another embodiment, this document discloses a system wherein said location is a retail location.

In a second aspect, this document discloses a method for monitoring a position of a fixture at a location, the method comprising: receiving, at a server, position information for a tracking unit attached to said fixture, said fixture having a designated position at said location; comparing said position information to a predetermined first radius associated with said fixture, said first radius being centered at said designated position; when said comparison indicates that said position of said fixture is within said first radius, determining that said fixture is in position; when said comparison indicates that said position of said fixture is outside of said first radius, determining that said fixture is out of position; and when said fixture is determined to be out of position, sending an alert to at least one computing device, wherein said server receives said position information by way of at least one intermediary device, said at least one intermediary device receiving signals from said tracking unit and reporting to said server.

In another embodiment, this document discloses a method wherein said fixture is also associated with a second radius, said second radius being larger than said first radius and said second radius being centered at said designated position, and said method further comprises the steps of: when said comparison indicates that said position of said fixture is outside said first radius, comparing said position information to said second radius; and when said fixture is outside of said second radius, determining that said fixture is outside of said location.

### BRIEF DESCRIPTION OF THE DRAWINGS

The present invention will now be described by reference to the following figures, in which identical reference numerals refer to identical elements and in which:

FIG. 1 is a block diagram of a system according to an aspect of the invention;

FIG. 2 shows a user interface for monitoring a specific display fixture, according to one embodiment of the invention;

FIG. 3 shows another user interface for monitoring the display fixture of FIG. 2;

FIG. 4 shows another user interface for monitoring the display fixture of FIG. 2;

FIG. 5 shows an exemplary mapping interface for monitoring fixtures;

FIG. 6 is a flowchart detailing a method according to an aspect of the invention; and

FIG. 7 is another flowchart detailing an embodiment of the method.

### DETAILED DESCRIPTION

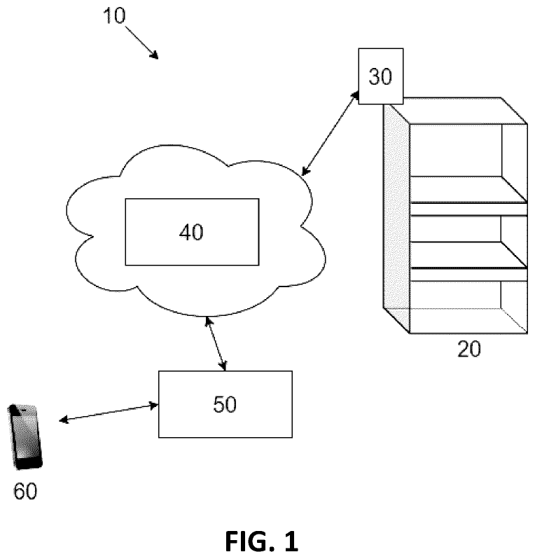

FIG. 1 is a block diagram of a system 10 according to an aspect of the invention. Tracking unit 30 is attached to fixture 20, which is positioned at a designated position at the location. The fixture 20 is also associated with/assigned a first radius that is centered at the designated position. Tracking unit 30 passes position information to server 50 via at least one intermediary device 40. That is, the tracking unit 30 passes a signal to the at least one intermediary device 40 which in turn reports to the server 50, as will be further described below. The server 50 receives the position information for the tracking unit 30 and compares the position information with the first radius. When the position information indicates that the position of the tracking unit 30 (and therefore the position of the fixture 20 to which the tracking unit 30 is attached) is outside of the first radius, the server 50 sends an alert to a designated computing device 60. The alert indicates that the fixture 20 is ‘out of position’, i.e., not at its designated position.

As should be understood, the term “fixture” as used herein includes any element of furniture at a location and/or of a location's layout. Fixtures are generally moveable, although they may be attached to part of the permanent structure of the location. For example, a fixture may be fastened to a wall, floor, or ceiling for support and/or security. However, fixtures may also be free-standing fixtures and/or on wheels, rollers, casters, or other movement aids. That is, some fixtures may be intended to have a range of positions at the location; i.e., the designated position of such a fixture would comprise a small area, rather than a single point. Fixtures include, without limitation: shelves and shelf units; displays and display units; racks; tables; cabinets; cupboards; other furniture elements; endcaps; and marketing elements, including without limitation marketing material, posters, free-standing displays, “standees” (i.e., free-standing human-shaped, animal-shaped, or other-shaped cutouts), etc. What fixtures are to be monitored can be determined by the user of the system for any specific location and/or need.

The tracking unit 30 is preferably a unit that securely attaches to the fixture 20 through adhesives or other fasteners. However, in further preferable embodiments, the tracking unit 30 is reusable, such that it can be removed from the fixture 20 and attached to a new fixture if and when desired. That is, the tracking units 30 are preferably securely but not permanently attached to the fixtures 20, such that accidental or unauthorized detachment is prevented.

The tracking unit 30 may communicate with the intermediary device(s) 40 through any suitable protocol or method, including wireless communication methods and protocols. In some embodiments, the tracking unit 30 sends a signal to the intermediary device(s) 40 via Bluetooth. In some embodiments, the tracking units 30 are Apple™ AirTags™ or similar Bluetooth-enabled devices, such as equivalent devices that run on Android™ or other operating systems. In such embodiments, the intermediary device(s) 40 is/are third-party and/or transient devices. Such devices include without limitation devices that are not permanently at the location and are not necessarily operated or overseen by the users of the system or by the entity managing the location. Such devices, in this exemplary embodiment, are configured to receive and send AirTags signals or equivalent tracking signals. For example, in one embodiment, the tracking units 30 are AirTags that provide position information to the AirTags cloud-based database via iPhones™ and other Apple devices at the location. Of course, such iPhones™ and Apple devices must be configured to receive and send AirTags information to be available to the system 10.

In such an embodiment, the server 50 retrieves the position information from the AirTags database. Of course, as should be understood, any suitable tracking unit(s) 30 and intermediary device(s) 40 may be used, and the invention is not limited to embodiments using AirTags. Similarly, depending on the embodiment, the intermediary device(s) 40 may report to the server 50 directly, using any suitable protocols; indirectly via additional intermediary device(s) 40; or, as in the AirTags example, to further intermediary device(s) 40 that report to the server 50 in response to a query from the server 50. Again, all suitable protocols and transmission methods should be understood as being within the scope of the invention.

The tracking unit 30, in some embodiments, transmits position information at predetermined intervals, e.g., every second, every minute, every hour, once a week, etc. As would be understood, different time intervals may be preferred for different fixtures 20. As such, in some embodiments, the time intervals are user-selectable.

The position information sent to the server 50 from the tracking unit 30 is geolocated information. As described above, the tracking unit 30 may use any suitable method to identify its position. In some embodiments, the tracking unit 30 comprises a geolocation receiving module that is in communication with a geolocation satellite or system. The geolocation satellite or system thereby provides GNSS (global navigation satellite system) data to the tracking unit 30. The tracking unit 30 can then pass this information to the intermediary device(s) 40 that report to the server 50. In other embodiments, the tracking unit 30 simply sends a ‘ping’ signal to the intermediary device(s) 40, and either the intermediary device(s) 40 or the server 50 determines the location of the tracking unit 30 based on an analysis of the ping. In some embodiments, e.g., where the intermediary device(s) 40 are configured in accordance with a third-party geolocation system such as the Apple AirTags system or similar, the third-party geolocation system determines the location of the tracking unit 30 and stores that location information, which can then be retrieved from the intermediary system by the server 50.

Again, the intermediary device(s) 40 may be any suitable device(s), including though not limited to transient and/or third-party devices. To be suitable, the intermediary device(s) comprise at least a receiver and a transmitter and are operable using the same protocol(s) as the tracking unit 30. For example, if the tracking unit 30 is configured to send a Bluetooth signal, the intermediary device(s) 40 should be configured to receive a Bluetooth signal. Accordingly, like the tracking unit 30, the intermediary device(s) 40 may use any suitable protocol or communication method known in the art. In embodiments where the tracking units 30 are Apple AirTags, for example, the intermediary device(s) 40 may be any iOS-enabled device that can receive AirTags information.

The first radius is centered at the designated position of the fixture 20 and is predetermined by a user when the tracking unit 30 is attached to the fixture 20. As should be clear, the first radius is a distance extending radially outward from the designated position in all directions, such that the ‘first radius’ describes a circle around the designated position, the circle's radius being the first radius. The first radius may be any suitable distance, such as 100 cm, 5 m, 20 m, etc., depending on the fixture's purpose, the location, the fixture's designated position, the fixture's physical size, the fixture's value, etc. As should be clear, multiple fixtures at a single location may have different radiuses and/or the same radius. The first radius is chosen at a distance significant enough to indicate that the fixture 20 is ‘out of position’ when the position information received from the tracking unit 30 is outside of the first radius.

In some embodiments of the system 10, the fixture 20 is also associated with a second radius. The second radius is larger or greater than the first radius and, like the first radius, is also centered at the designated position. Again, for clarity, the second radius describes a circle centered at the designated position, the circle's radius being the second radius. The second radius is preferably chosen at a distance that indicates that the fixture 20 is no longer at the location when the position information received from the tracking unit 30 is outside of the second radius. The size of the second radius thus typically depends on the area of the location. As examples, a small retail location in a covered mall could have a second radius of 30 m or less, while a large free-standing retail location could have a second radius of 300 m or more. The user of the system can select a desired second radius for any particular fixture and/or location.

In some embodiments, the server 50 provides a map interface through which a user can view the positions of the various tracking units 30 being monitored (and thus the positions of the associated fixtures 20). Data to populate such a map interface is, in some embodiments, stored in a database accessible by the server 50. In some such embodiments, further, the database is updated only if a fixture has moved out of its designated position. The server 50 in such embodiments would update the database to indicate a change in status of the fixture 20 for which the alert is received. In other embodiments, the database is continually updated, and/or updated at predetermined intervals, regardless of whether alerts have been received since the last update.

The server 50, in some embodiments, uses a third-party mapping API to display the position data of the various tracking units 30 being monitored. The tracking units 30/fixtures 20 are, in some embodiments, displayed as pins or flags on the map. The person skilled in the art would conceive of many possible display options for such information.

As well, the locations displayed on the map are preferably displayed with as much precision as possible. However, the display may, in some embodiments or for some fixtures, show the last-known position of the fixture or the best estimate of the fixture's current position, depending on the amount of information available. In particular, if the fixture 20 has been taken a significant distance from the location and is out of range of any suitable monitoring device, data as to the current position of the fixture 20 may not be available with any accuracy.

As should be understood, the tracking unit 30 is capable of sending position information to any nearby receiver/transmitter (i.e., suitable intermediary device(s)). The server 50 is further capable of receiving information from any such suitable intermediary device(s) and/or of retrieving information from a suitable third-party database. For example, if a fixture 20 with tracking unit 30 has been moved far from its designated position, the tracking unit 30 can still communicate with the server 50 by way of an intermediary device 40 at the new position, such that the server 50 determines that the fixture 20 is out of position/out of location.

The designated computing device 60 is any computing device that the user of the system 10 has designated to receive alerts. As should be clear, although a smartphone is shown in FIG. 1 as the designated computing device 60, this is simply for illustrative convenience. The designated computing device 60, depending on the embodiment, may be a mobile computing device, such as a smartphone, laptop, or tablet, a desktop or other personal computing device or any other suitable device. Further, the server 50 may send alerts to multiple such designated computing devices 60 at one time. For example, the user may wish to receive alerts on both their smartphone and their laptop at once.

The alert comprises at least one of a push notification (i.e., that appears on a display area of the designated computing device 60 regardless of the user's interaction with the designated computing device), an SMS message, a notification to a connected application on the designated computing device 60, and an email message to a user's email account that is viewable on the designated computing device 60. The alert, in some embodiments, comprises a link to more information about the fixture 20, such as a link to a database entry for the fixture 20 or a link that, when selected by the user of the designated computing device 60, opens a map interface as described above that displays a position or estimated position of the fixture 20.

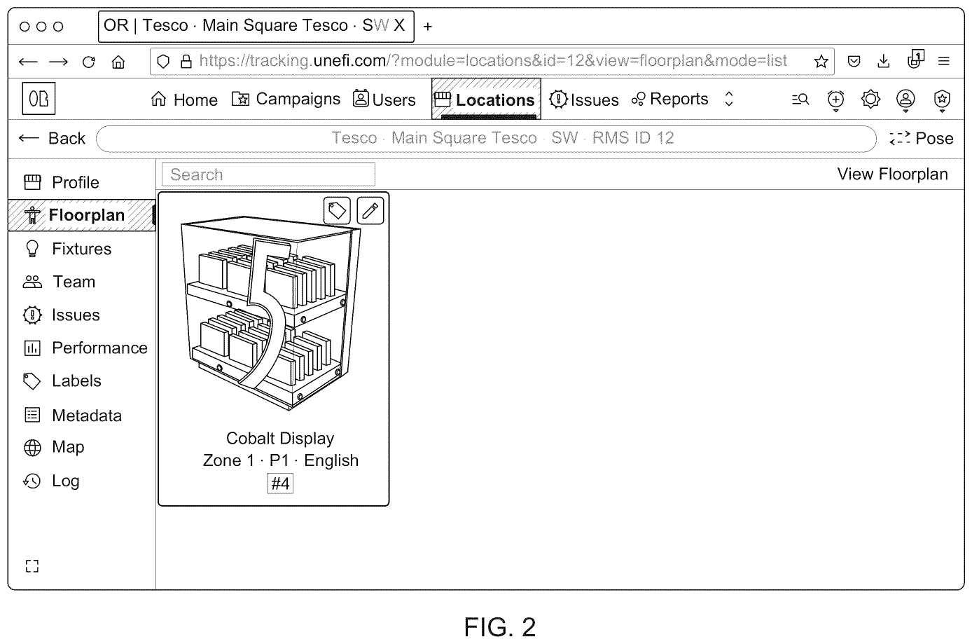

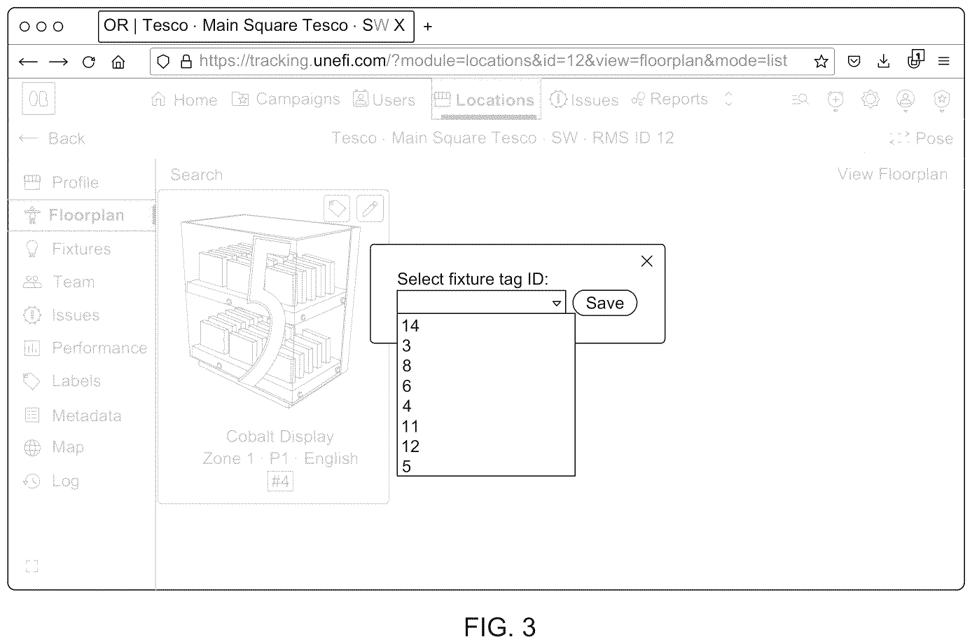

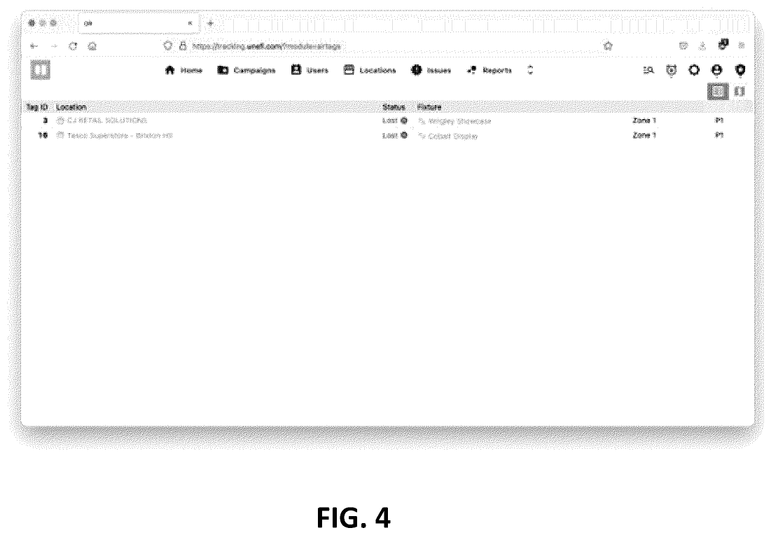

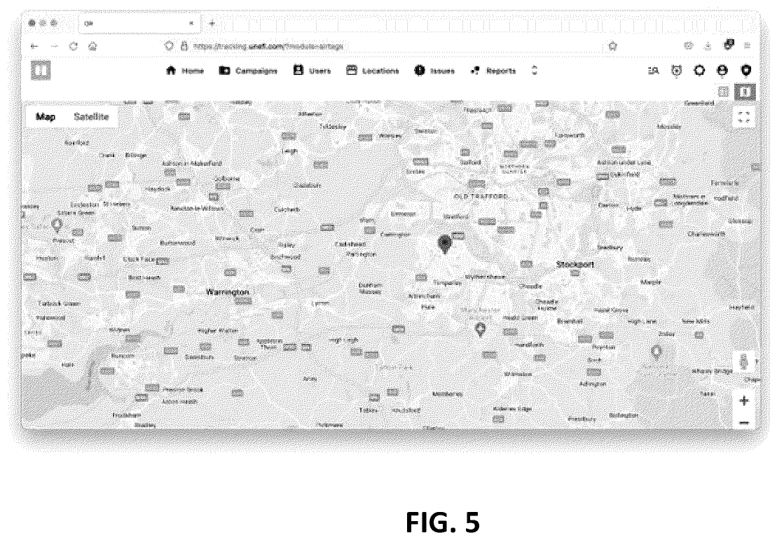

FIG. 2 shows an interface for associating a specific display fixture with a specific location and designated position, according to one embodiment of the invention. FIG. 3 shows an interface for associating a tracking unit with the specific display fixture of FIG. 2. FIG. 4 shows an interface displaying monitoring information for specific fixtures, including the specific display fixture of FIG. 2. As can be seen, both of the fixture being monitored in FIG. 4 are listed as “Lost”, indicating that they have been removed from their designated positions and that their current locations are undetermined (i.e., due to the removal of or damage to the tracking unit 30, or due to a lack of connectivity between the tracking unit 30 and the server 50). FIG. 5 shows a mapping interface showing a single pin, representing a single fixture. Of course, as should be understood, the interfaces shown in FIGS. 2 to 5 are purely exemplary and should not be construed as limiting the invention in any way.

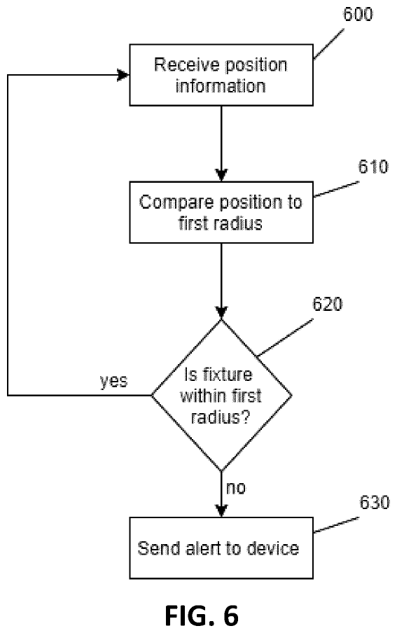

FIG. 6 is a flowchart detailing one aspect of the invention. At step 600, position information is received for a tracking unit. At step 610, the position information is compared to the first radius associated with the tracking unit. If, at decision 620, it is determined that the position of the fixture is within the first radius, no action is taken and new position information is awaited at step 600. However, if decision 620 determines that the position of the fixture is outside of the first radius, an alert is sent to at least one computing device at step 630.

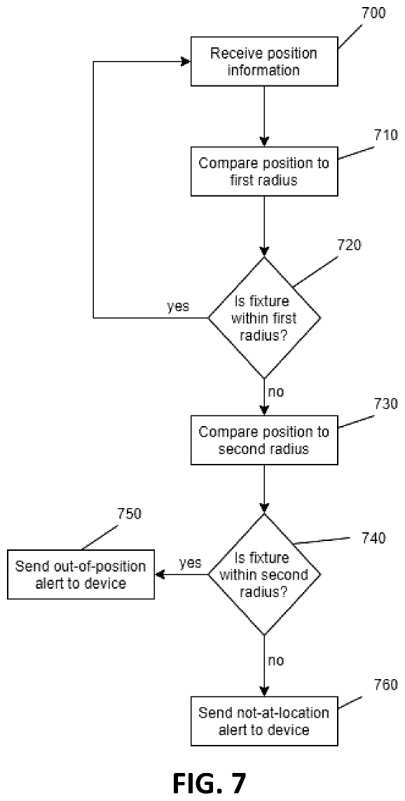

FIG. 7 is another flowchart detailing an embodiment of the method of FIG. 6. Similarly to FIG. 6, position information is received for a tracking unit at step 700 and is compared to the first radius at step 710. Again, at decision 720, if it is determined that the position of the fixture is within the first radius, no action is taken and new position information is awaited at step 700. However, if decision 720 determines that the position of the fixture is outside of the first radius, another comparison is performed at step 730. That is, at step 730, the position information is compared to the second radius associated with the tracking unit. If the position of the fixture is within the second radius (decision 740), an alert is sent to at least one computing device at step 750. This alert indicates that the fixture is out-of-position but still at the location: i.e., outside of the first radius but within the second radius. However, if, at decision 740, the position of the fixture is determined to be outside of the second radius, a different alert is sent to the at least one computing device at step 760. This alert indicates that the fixture is not at the location.

As used herein, the expression “at least one of [x] and [y]” means and should be construed as meaning “[x], [y], or both [x] and [y]”.

It should be clear that the certain elements of the present invention may be implemented as software modules in an overall software system. As such, the present invention may thus in part take the form of computer-executable instructions that, when executed, implements various software modules with predefined functions.

Further, embodiments of the invention may be executed by a computer processor or similar device programmed in the manner of method steps, or may be executed by an electronic system which is provided with means for executing these steps. Similarly, an electronic memory means such as computer diskettes, CD-ROMS, Random Access Memory (RAM), Read Only Memory (ROM) or similar computer software storage media known in the art, may be programmed to execute such method steps. As well, electronic signals representing these method steps may also be transmitted via a communication network.

Further, elements of embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Some elements can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A system for monitoring a position of a fixture at a location, the system comprising:
a tracking unit attached to said fixture; and
a server for receiving signals from said tracking unit,
wherein said fixture has a designated position at said location and said fixture is associated with a first radius,
wherein said first radius is centered at said designated position, wherein said server receives position information for said fixture by way of said tracking unit and by way of at least one intermediary device, said at least one intermediary device receiving signals from said tracking unit and reporting to said server,
and wherein, when said position information indicates that said position of said fixture is outside of said first radius, said server sends an alert to at least one designated computing device.

2. The system according to claim 1, wherein said alert indicates that said fixture is out of said designated position.

3. The system according to claim 1, wherein said server receives reports related to a plurality of tracking units, said plurality of tracking units being attached to different fixtures at said location.

4. The system according to claim 1, wherein said fixture is also associated with a second radius, said second radius being larger than said first radius and said second radius being centered at said designated position, and wherein, when said position information indicates that said fixture is outside said second radius, said alert indicates that said fixture has been removed from the location.

5. The system according to claim 1, wherein said alert comprises a link to a map interface, and, when accessed by a user, said map interface displays an estimated current location of said fixture.

6. The system according to claim 1, further comprising a map interface for viewing an estimated current location of said fixture.

7. The system according to claim 1, wherein said fixture comprises at least one of:
a shelf unit;
a display unit;
an endcap;
a standee;
a rack;
a table;
a cabinet;
a cupboard;
a furniture element; and
a marketing element.

8. The system according to claim 1, wherein said location is a retail location.

9. A method for monitoring a position of a fixture at a location, the method comprising:
receiving, at a server, position information for a tracking unit attached to said fixture, said fixture having a designated position at said location;
comparing by the server said position information to a predetermined first radius associated with said fixture, said first radius being centered at said designated position;
when said comparison indicates that said position of said fixture is within said first radius, determining by the server that said fixture is in position;
when said comparison indicates that said position of said fixture is outside of said first radius, determining by the server that said fixture is out of position; and
when said fixture is determined to be out of position, sending from the server an alert to at least one computing device,
wherein said server receives said position information by way of at least one intermediary device, said at least one intermediary device receiving signals from said tracking unit and reporting to said server.

10. The method of claim 9, wherein said fixture is also associated with a second radius, said second radius being larger than said first radius and said second radius being centered at said designated position, and said method further comprises the steps of:
when said comparison indicates that said position of said fixture is outside said first radius, comparing by the server said position information to said second radius; and
when said position of said fixture is outside of said second radius, determining by the server that said fixture is outside of said location.
